(19) United States
(12) Patent Application Publication
(10) Pub. No.: US 2016/0226656 A1
(43) Pub. Date: Aug. 4, 2016

(54) PHASE DETECTOR AND DIGITAL PLL CIRCUIT USING THE SAME

(71) Applicant: Semiconductor Technology Academic Research Center, Yokohama-shi (JP)

(72) Inventor: Kenichi OKADA, Tokyo (JP)

(73) Assignee: Semiconductor Technology Academic Research Center, Yokohama-shi (JP)

(21) Appl. No.: 14/831,111

(22) Filed: Aug. 20, 2015

(30) Foreign Application Priority Data
Jan. 29, 2015 (JP) 2015-015324

(51) Int. Cl. H04L 7/033

(52) U.S. Cl. CPC H04L 7/0331

(57) ABSTRACT

According to one embodiment, a phase detector includes an amplifier and an analog-to-digital converter. The amplifier amplifies a voltage of a signal which is output from a digitally-controlled oscillator and is held based on a reference signal. The analog-to-digital converter converts the voltage amplified by the amplifier into a digital signal, based on the reference signal.

### CROSS-REFERENCE TO RELATED APPLICATIONS

This application is based upon and claims the benefit of priority from Japanese Patent Application No. 2015-015324, filed Jan. 29, 2015, the entire contents of which are incorporated herein by reference.

### FIELD

Embodiments described herein relate generally to an all-digital phase-locked loop circuit.

### BACKGROUND

A digital PLL circuit using a time-to-digital converter (TDC), a digitally-controlled oscillator (DCO), etc., has been developed.

In a TDC-based PLL (TDC-PLL) circuit, a resolution can hardly be improved since a phase difference (time difference) between a reference clock signal and a DCO output signal is detected in a time domain by the TDC. Furthermore, since the TDC-PLL circuit executes digitization in the time domain, reduction of jitter is difficult.

In addition, a PLL circuit comprising a combination of a charge pump, a sub-sampling phase detector which detects a frequency without frequency-dividing an output signal of a voltage control oscillator, etc., has been developed. However, digitization of a PLL circuit using a charge pump has been difficult.

### BRIEF DESCRIPTION OF THE DRAWINGS

FIG. 1 is a diagram schematically showing a digital PLL circuit of the present embodiment.

FIG. 2 is a diagram showing a digital signal processing region of the circuit shown in FIG. 1.

FIG. 3 is a diagram schematically showing a digital phase detector of the present embodiment.

FIGS. 4A, 4B and 4C are illustrations showing operations of a sample-and-hold circuit shown in FIG. 3.

FIGS. 5A and 5B are illustrations showing operations of a digital phase detector shown in FIG. 3.

FIG. 6 is a graph showing the operations of the digital phase detector shown in FIG. 3.

FIG. 7 is a diagram schematically showing an implementation example of the digital PLL circuit of the present embodiment.

FIG. 8 is a circuit diagram showing an example of a digitally-controlled oscillator shown in FIG. 7.

FIG. 9 is a circuit diagram showing an example of a sample-and-hold circuit shown in FIG. 7.

FIG. 10 is a circuit diagram showing an example of an analog-to-digital converter shown in FIG. 7.

FIG. 11 is a circuit diagram showing a first modified example of the present embodiment.

FIG. 12 is a circuit diagram showing a second modified example of the present embodiment.

FIG. 13 is a circuit diagram showing a third modified example of the present embodiment.

### DETAILED DESCRIPTION

In general, according to one embodiment, a phase detector includes an amplifier and an analog-to-digital converter. The amplifier amplifies a voltage of a signal which is output from a digitally-controlled oscillator and is held based on a reference signal. The analog-to-digital converter converts the voltage amplified by the amplifier into a digital signal, based on the reference signal.

Embodiments will be described hereinafter with reference to the accompanying drawings. Elements like or similar in the drawings are denoted by similar reference numbers and symbols, and are not described in detail here.

FIG. 1 schematically shows a digital PLL circuit 10 of one of the embodiments. The digital PLL circuit 10 is constituted by, for example, a core loop 11 and a frequency-locked loop 21. However, the frequency-locked loop 21 can be omitted.

The core loop 11 is constituted by an analog-to-digital-converter-based phase detector (ADC-PD) 12, a digital loop filter (DLF) 13, and a DCO 31. The core loop 11 detects a phase difference between an output signal f_{DCO} of the DCO 31 and a reference clock signal (reference signal) f_{REF} in a voltage domain by the ADC-PD 12, and controls a phase of a signal output from the DCO 31, based on the detected phase difference.

The ADC-PD 12 samples the voltage value of the output signal f_{DCO} (also called the oscillation frequency) of the DCO 31 with the reference clock signal f_{REF} as explained later. The ADC-PD 12 constitutes what is called a sub-sampling phase detector, and has a function of amplifying the sampled voltage and converting the amplified voltage into, for example, a 4-bit digital signal.

The digital signal output from the ADC-PD 12 is supplied to the DLF 13. The DLF 13 constitutes a digital low-pass filter. The DLF 13 produces, for example, an 18-bit control signal to control the DCO 31, based on the digital signal supplied from the ADC-PD 12 and a digital signal supplied from an adder 23 to be explained later. The control signal output from the DLF 13 is supplied to the DCO 31. The DCO 31 is constituted by a digitally-controlled oscillator including an LC resonant circuit, for example, a push-pull class-C DCO, as explained later, and the oscillation frequency is varied by varying the capacitance of a capacitor with a control signal.

In contrast, the frequency-locked loop 21 is constituted by a counter 22, an operating unit such as the adder 23, the DLF 13 and DCO 31. The frequency-locked loop 21 detects the oscillation frequency f_{DCO} of the DCO 31, and controls the oscillation frequency f_{DCO} of the DCO 31, based on a frequency control word (frequency control signal).

The counter 22 is constituted by, for example, a 12-bit counter, and counts the oscillation frequency f_{DCO} of the DCO 31, based on the reference clock signal f_{REF}. For example, the 12-bit digital signal output from the counter 22 (i.e., the oscillation frequency f_{DCO} of the DCO 31) is supplied to the adder 23. The adder 23 acquires a difference between the digital signal output from the counter 22 and, for example, the 12-bit frequency control word and outputs the difference as, for example, an 8-bit digital signal. The digital signal output from the adder 23 is supplied from the DLF 13. The DLF 13 produces the control signal to control the DCO 31 as explained above.

In FIG. 1, the DLF 13 produces the 18-bit control signal to control the DCO 31, based on the output signals from the ADC-PD 12 and the adder 23, but the constitution of the DLF 13 can be variously modified.

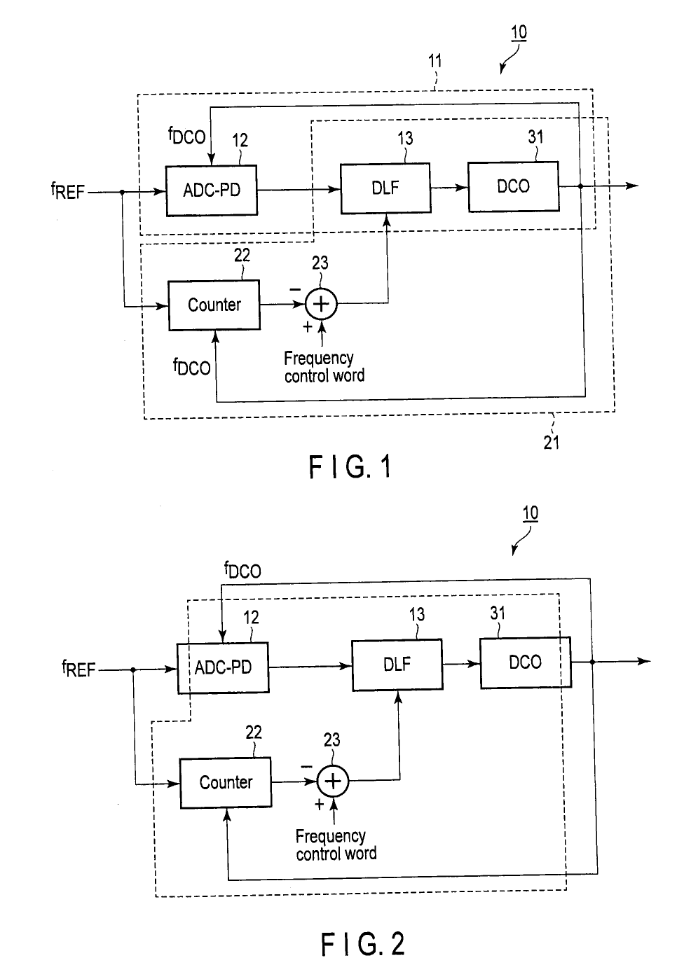

FIG. 2 shows a region processed with the digital signal, in the circuit shown in FIG. 1. In other words, a region surrounded by a broken line represents a region processed by the digital signal, and the region other than certain parts of the ADC-PD 12 and the DCO 31 is entirely processed by the digital signal. A digital PLL circuit can therefore be implemented in the present embodiment.

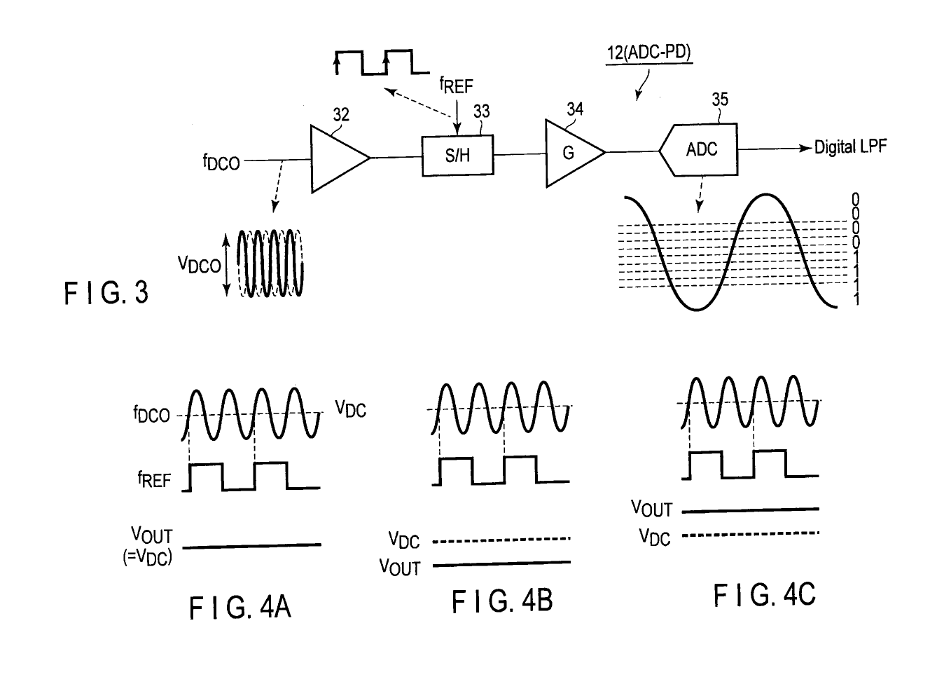

FIG. 3 schematically shows an example of the ADC-PD 12. The ADC-PD 12 is constituted by, for example, a buffer 32 for isolation which receives the output signal f_{DCO} of the DCO 31, a sample-and-hold circuit (S/H) 33, an amplifier 34, and an analog-to-digital converter (ADC) 35. The S/H 33, the amplifier 34, and ADC 35, other than the buffer 32, are operated with the reference clock signal f_{REF}.

The S/H 33 samples and holds the output signal f_{DCO} of the DCO 31 supplied from the buffer 32, based on the reference clock signal f_{REF}, and converts a phase difference between the output signal f_{DCO} of the DCO 31 and the reference clock signal f_{REF} into a voltage difference and holds the voltage difference.

FIGS. 4A, 4B and 4C show an operational principle of the S/H 33. The S/H 33 is constituted by, for example, a capacitor and a switch element which is turned on or off based on the reference clock signal f_{REF}, as explained later. The phase difference between the output signal f_{DCO} of the DCO 31 and the reference clock signal f_{REF} is held as the voltage difference in the capacitor.

As shown in FIG. 4A, if the phases of the output signal f_{DCO} of the DCO 31 and the reference clock signal f_{REF} match (i.e., the phases are locked), output voltage V_{OUT} of the S/H 33 becomes, for example, voltage V_{DC}.

FIG. 4B shows a case where the phase of the reference clock signal f_{REF} leads the phase of the output signal f_{DCO} of the DCO 31. In this case, the output voltage V_{OUT} of the S/H 33 becomes, for example, a voltage lower than the voltage V_{DC}.

FIG. 4C shows a case where the phase of the reference clock signal f_{REF} lags the phase of the output signal f_{DCO} of the DCO 31. In this case, the output voltage V_{OUT} of the S/H 33 becomes, for example, a voltage higher than the voltage V_{DC}.

The output voltage of the S/H 33 is amplified by the amplifier 34. The amplifier 34 is constituted by, for example, a linear operational amplifier, and amplifies the output voltage of the S/H 33 in a linear shape. The output voltage of the amplifier 34 is supplied to the ADC 35.

The ADC 35 is constituted by, for example, a 4-bit flash A/D converter. The ADC 35 divides the voltage amplified by the amplifier 34 into a plurality of regions, processes the voltages of the divided regions in parallel and converts the voltages into a plurality of digital signals. After this, the plurality of digital signals are encoded to 4-bit digital signals. The ADC 35 is not limited to a flash A/D converter but, for example, a successive approximation type or pipeline type A/D converter can be applied as the ADC 35. In addition, the resolution is not limited to four bits, but may be greater than or equal to four bits.

Thus, the phase difference can be detected at high accuracy by amplifying the sampled voltage by the amplifier 34 and A/D-converting the amplified voltage. Furthermore, the time for A/D-conversion can be reduced by dividing the voltage amplified by the amplifier 34 into a plurality of regions and converting the voltages into digital signals.

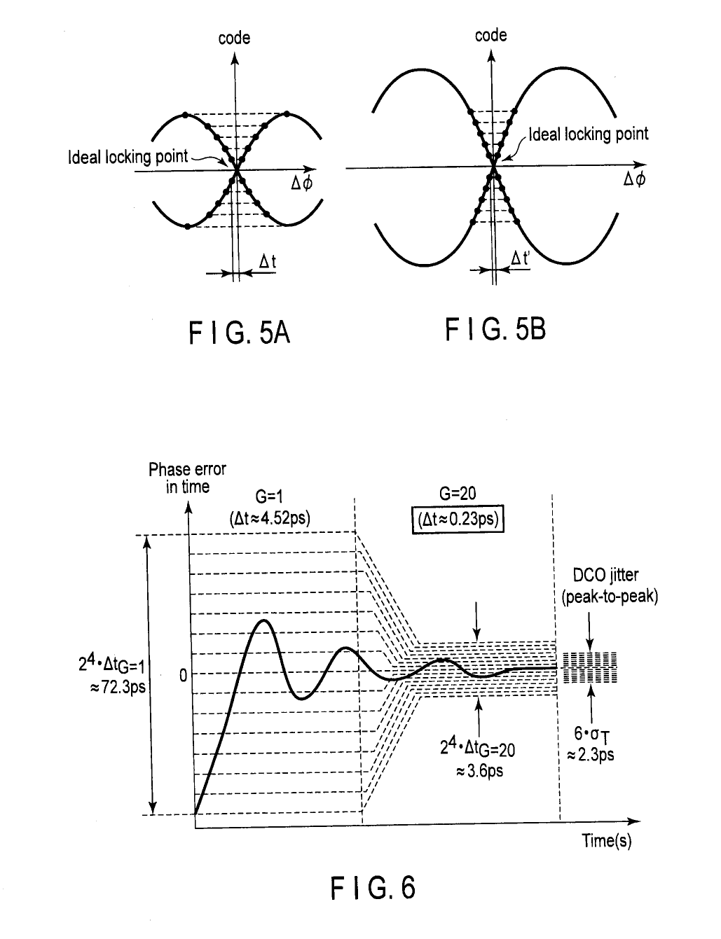

FIG. 5A shows not amplifying but merely A/D-converting the output voltage of the S/H 33 (FIGS. 5A and 5B show outputting a differential voltage from the DCO 31 and the S/H 33 as explained later). In this case, an equivalent time resolution Δt of a conversion code which is output from the ADC 35 is represented by the following equation:

Δt≈Vrange/2^{N}·V_{DCO}·½πf_{DCO}

where N is a bit number of the ADC 35, Vrange is a range of an input voltage of the ADC 35, V_{DCO} is an oscillation amplitude (output voltage) of the DCO 31, and f_{DCO} is an oscillation frequency of the DCO 31.

In contrast, FIG. 5B shows amplifying the output voltage of the S/H 33 by the amplifier 34 and A/D-converting the amplified output voltage by the ADC 35. In this case, an equivalent time resolution Δt′ of the conversion code which is output from the ADC 35 is represented by the following equation:

Δt′=Δt/G

where G is a gain of the amplifier 34.

Thus, the equivalent time resolution Δt′ in a case where the output voltage of the S/H 33 is amplified by the amplifier 34 and A/D-converted is improved by one G-th as compared with the case where the output voltage is not amplified and merely A/D-converted. The resolution of the ADC 35 is therefore improved by a gain of the amplifier 34.

More specifically, if it is assumed that, for example, the Vrange of the DCO 31 is 1V, f_{DCO} is 2.2 GHz, V_{DCO} is 1V, the gain G of the amplifier 34 is 20, bit number N of the ADC 35 is four bits, and the resolution is 50 mV, the equivalent time resolution Δt′ is approximately 0.23 ps based on the above equation.

FIG. 6 shows the equivalent time resolution Δt′ (represented as Δt in the drawing) in a case of not amplifying the output voltage by the amplifier 34 (G=1) and a case of amplifying the output voltage by the amplifier 34 (G=20). As clarified from FIG. 6, the equivalent time resolution in the case of amplifying the output voltage by the amplifier 34 (Δt=0.23 ps) is improved as compared with the case of not amplifying the output voltage (Δt=4.52 ps). For this reason, the jitter of the DCO 31 is reduced by controlling the DCO 31 with the output signal from the ADC 35. Noise in the band can be therefore reduced.

In the ADC-PD 12 shown in FIG. 3, the buffer 32 can be omitted if the output signal of the DCO 31 is a level adequate for subsequent processing.

In addition, the S/H 33, the amplifier 34 and the ADC 35 of the ADC-PD 12 shown in FIG. 3 are explained as independent circuits, but are not limited to these. For example, the S/H 33 and the amplifier 34 can also be designed as circuits integral with the ADC 35. Since the ADC 35 is operated based on the reference clock signal f_{REF}, the ADC 35 can comprise the sample-and-hold function and the amplifying function. In other words, the ADC 35 can be designed to hold the output signal (output voltage) f_{DCO} based on the reference clock signal f_{REF}, amplify the held voltage and convert the voltage into a digital signal.

### Advantage of Embodiment

According to the embodiment, the ADC-PD 12 samples the phase difference between the output signal f_{DCO} of the DCO 31 and the reference signal f_{REF} as the voltage by the S/H 33, amplifies the sampled voltage by the amplifier 34, and converts the voltage into the digital signal by the ADC 35. For this reason, the ADC-PD 12 can improve the equivalent time resolution as compared with the TDC. The PLL circuit in which the jitter is reduced as compared with a TDC-based PLL circuit can be constituted by controlling the DCO 31 with the output signal from the ADC-PD 12.

In addition, sampling a time difference between two signals is difficult in the TDC, but the ADC-PD 12 samples the time difference (phase difference) between two signals as the voltage. For this reason, the gain of the amplifier 34 can be changed and AD-converted again by the ADC 35. The resolution can be therefore improved. The improvement will be explained later in modified examples.

Furthermore, the units subsequent to the S/H 33 are driven with the reference clock signal f_{REF}, in the ADC-PD 12, the power consumption can be reduced.

Moreover, by using the ADC-PD 12, the digital PLL circuit can be constituted.

### Implementation Example

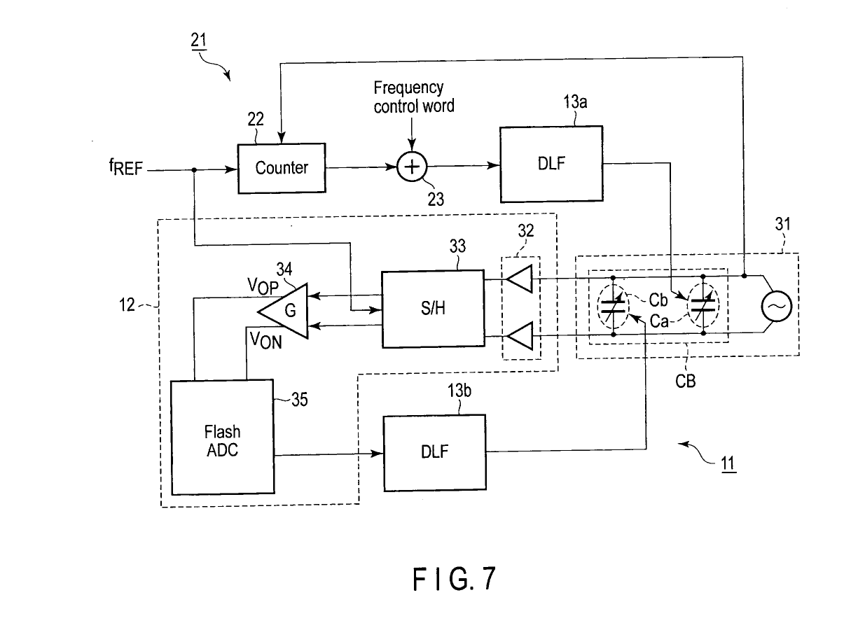

FIG. 7 shows an implementation example of a digital PLL circuit based on the ADC-PD of the present embodiment. In FIG. 7, the core loop 11 alone will be explained since a configuration of the frequency-locked loop 21 is similar to that shown in FIG. 1. 13a denotes a DLF included in the frequency-locked loop 21 and 13b denotes a DLF included in the core loop 11.

The DCO 31 comprises a capacitor bank CB constituting an LC resonant circuit. The capacitor bank CB comprises a plurality of variable capacitances Ca and Cb. The variable capacitance Ca has a capacitance varied with the output signal from the DLF 13a included in the frequency-locked loop 21. The variable capacitance Cb has a capacitance varied with the output signal from the DLF 13b included in the core loop 11. The variable capacitance Ca is for, for example, coarse adjustment and the variable capacitance Cb is for, for example, intermediate adjustment and fine adjustment. However, the constitution of the capacitor bank CB is not limited to this, but the intermediate adjustment and the fine adjustment may be controlled separately.

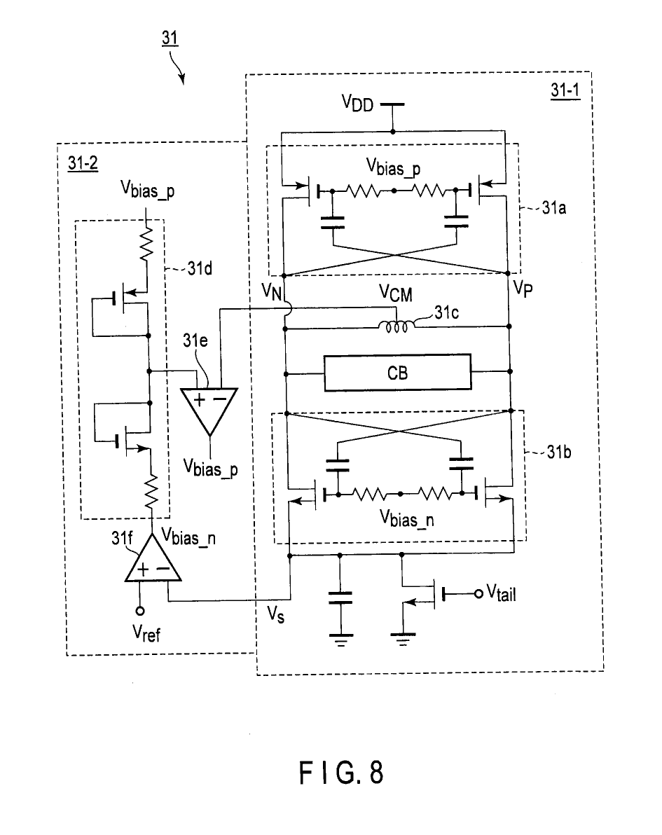

FIG. 8 shows an example of the DCO 31. The DCO 31 is, for example, a push-pull class-C DCO. The DCO 31 comprises an oscillator circuit 31-1 and a replica bias circuit 31-2.

The oscillator circuit 31-1 comprises a circuit 31a comprising a P-channel MOS transistor (hereinafter called PMOS) pair connected to cross each other, a circuit 31b comprising an N-channel MOS transistor (hereinafter called NMOS) pair connected to cross each other, an inductor 31c, a capacitor bank CB, etc.

The replica bias circuit 31-2 is constituted by a replica circuit 31d of PMOS and NMOS, and differential amplifiers 31e and 31f. The differential amplifier 31e produces a bias voltage Vbias_p supplied to a gate electrode of the PMOS pair, based on an output voltage of the replica circuit 31d and a voltage at a middle point of the inductor 31c. The differential amplifier 31f produces a bias voltage Vbias_n supplied to gate electrodes of the NMOS pair, based on the reference voltage Vref and a voltage Vs of source electrodes of the NMOS pair.

In general, the push-pull class-C DCO has a problem of unbalance in oscillation amplitude. However, the unbalance in oscillation amplitude can be solved by using the replica bias circuit 31-2.

In addition, at the oscillation start of the push-pull class-C DCO, in general, the voltage amplitude is small, and the gate bias voltage remains lower than a threshold voltage due to the class-C bias. In contrast, by using the replica bias circuit 31-2, both the bias voltages Vbias_p and Vbias_n supplied to the respective gate electrodes of the PMOS pair and the NMOS pair connected to cross each other are boosted, at the start of oscillation, and the PMOS pair and the NMOS pair are controlled to execute the class-C operation.

Furthermore, by using the replica bias circuit 31-2, unbalance in voltage caused by mismatch of gm of the PMOS pair and mismatch of gm of the NMOS pair can be solved.

In FIG. 7, the differential output signal generated from the DCO 31 is supplied to the S/H 33 via the buffer 32.

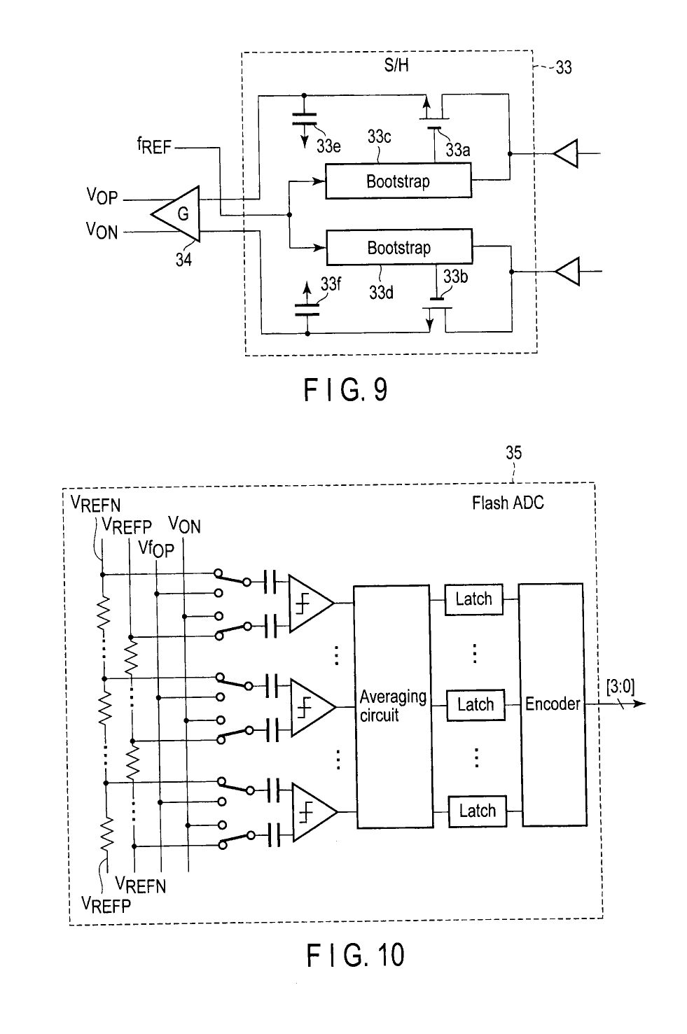

FIG. 9 shows an example of the S/H 33. The S/H 33 is constituted by, for example, NMOS 33a and 33b, bootstraps 33c and 33d, and capacitors 33e and 33f. The bootstraps 33c and 33d boost the reference clock signal f_{REF} and supply the signal to gate electrodes of the NMOS 33a and 33b respectively. The NMOS 33a and 33b are turned on at a rising edge of the reference clock signal f_{REF} and charge the capacitors 33e and 33f with the differential output signal f_{DCO} generated from the DCO 31. The operation of the S/H 33 is shown in FIGS. 4A, 4B and 4C.

The output voltage of the S/H 33 is supplied to the amplifier 34 and then amplified. Output voltages V_{OP} and V_{ON} of the amplifier 34 are supplied to, for example, a 4-bit flash ADC 35 shown in FIG. 7 and converted into digital signals.

FIG. 10 shows an example of the 4-bit flash ADC 35. However, the configuration of the flash ADC 35 is not limited to this.

As shown in FIG. 7, the output signal of the ADC 35 is supplied to the variable capacitance Cb via the DLF 13b.

In the ADC-PD 12 shown in FIG. 7, the S/H 33 and the amplifier 34 are explained as circuits different from the flash ADC 35, but are not limited to this and can be integrated with the flash ADC 35 as explained above.

### First Modified Example

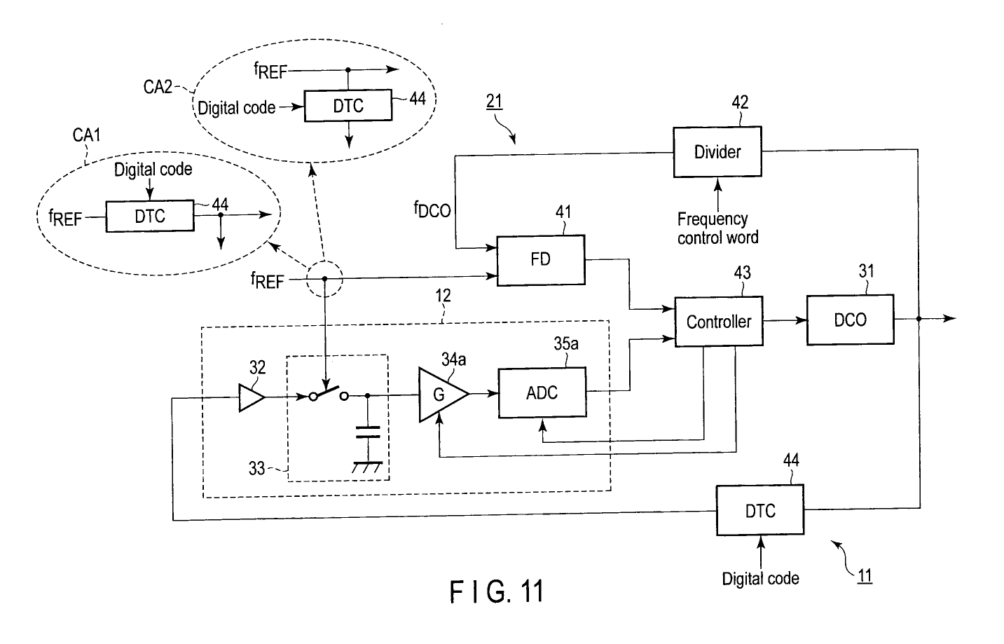

FIG. 11 shows a first modified example of the present embodiment.

In FIG. 11, the frequency-locked loop 21 comprises, for example, a frequency detector (FD) 41 and a divider 42. The FD 41 is constituted by, for example, a counter and detects the output signal f_{DCO} of the DCO 31 frequency-divided by the divider 42, based on the reference clock signal f_{REF}. A frequency division ratio of the divider 42 is varied based on, for example, a frequency control word.

In the above-explained embodiment, a gain of the amplifier 34 is fixed. In contrast, the amplifier 34a is constituted by a variable gain amplifier in which the gain can be varied, in a modified example. Furthermore, the output signal of the ADC 35 is supplied to a controller 43. The controller 43 produces a control signal of the DCO 31, based on an output signal of the FD 41 and the output signal of the ADC 35, and controls the gain of the amplifier 34a and the operation of the ADC 35.

More specifically, in a state in which the phase difference is sampled by the S/H 33, the controller 43 sets a first gain at the amplifier 34a and AD-converts an output voltage of the amplifier 34a by the ADC 35. Consequently, if the output voltage of the amplifier 34a has a margin as compared with a range (full range) of an input voltage of the ADC 35, the controller 43 sets a second gain greater than the first gain at the amplifier 34a such that the output voltage of the amplifier 34a corresponds to the full range of the ADC 35. Thus, the gain of the amplifier 34a is varied and A/D-converted again by the ADC 35. The resolution of the ADC 35 can be improved by varying the gain of the amplifier 34a.

In the embodiment, the PLL circuit which outputs a signal obtained by multiplying the reference clock signal f_{REF} by an integer is explained. However, the ADC-PD of the present embodiment can also be applied to a PLL circuit configured to output a signal obtained by multiplying the reference clock signal f_{REF} by a decimal place number.

In FIG. 11, the output signal f_{DCO} of the DCO 31 is supplied to the ADC-PD 12 via a digital-to-time converter (DTC) 44. The DTC 44 is a circuit which gives a delay to signal, based on a digital code, and can give a positive delay or a negative delay to the signal in accordance with a digital code. By giving a delay to the output signal f_{DCO} of the DCO 31 by the DTC 44, the PLL circuit which outputs a signal obtained by multiplying the reference clock signal f_{REF} by a decimal place number can be constituted.

The DTC 44 delays the output signal f_{DCO} of the DCO 31, but the PLL circuit which outputs a signal obtained by multiplying the reference clock signal fREF by a decimal place number can also be constituted by delaying the reference clock signal f_{REF} by the DTC 44, as illustrated as CA 1 and CA 2 in FIG. 11. In the CA 1, the reference clock signal f_{REF} delayed by the DTC 44 is supplied to the S/H 33 and the FD 41. In the CA 2, the reference clock signal f_{REF} delayed by the DTC 44 is supplied to the S/H 33 and the reference clock signal f_{REF} which is not delayed by the DTC 44 is supplied to the FD 41.

In the ADC-PD 12 shown in FIG. 11, the S/H 33 and the amplifier 34a are explained as circuits different from the ADC 35, but are not limited to this and can be integrated with the flash ADC 35 as explained above.

Furthermore, the frequency-locked loop 21 can be omitted.

### Second Modified Example

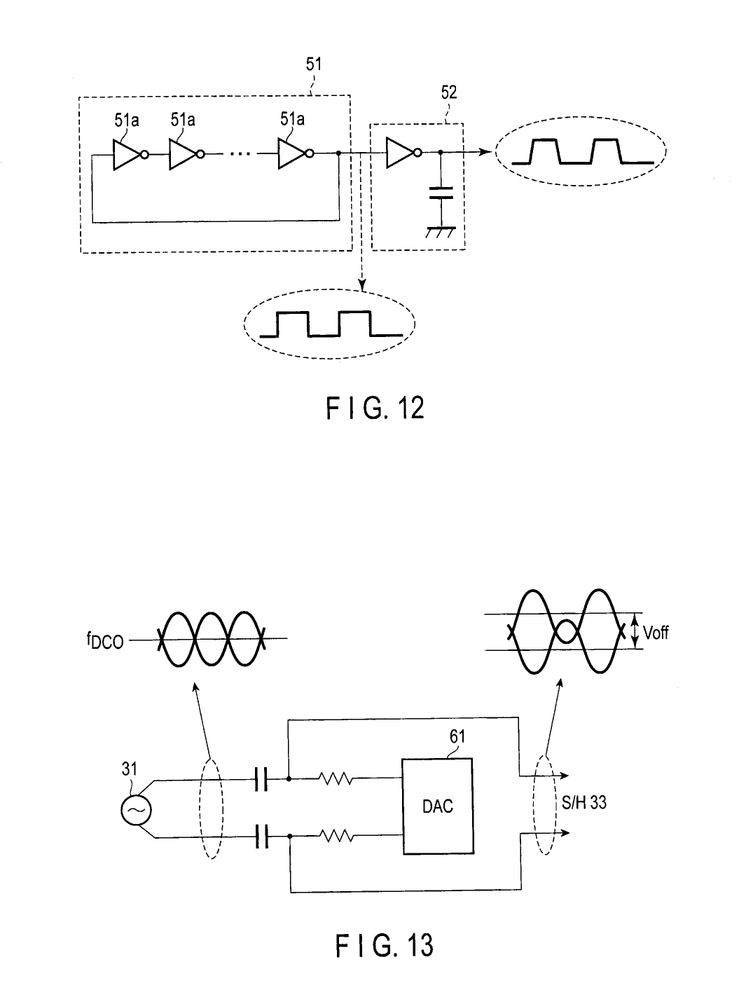

FIG. 12 shows a second modified example of the present embodiment, and a modified example of the DCO 31.

In the embodiment, the push-pull class-C DCO comprising an LC resonant circuit is explained as an example of the DCO 31. In contrast, the second modified example comprises, for example, a DCO 51 using a ring-type digitally-controlled oscillator. The DCO 51 is constituted by a plurality of inverter circuits 51a connected in a ring shape. An oscillation frequency of the DCO 51 can be varied by, for example, controlling a drive current of each of inverter circuits 51a with the digital signal.

An output signal of the DCO 51 is supplied to a waveform shaping circuit 52. The waveform shaping circuit 52 sets tilt on the rise and the fall of a rectangular wave which is output from the DOC 51.

By thus using the waveform shaping circuit 52, the signal f_{DCO} having the tilt on the rise and the fall can be generated from the output signal of the DCO 51. For this reason, the S/H 33 can sample the phase difference between the output signal f_{DCO} of the waveform shaping circuit 52 and the reference clock signal f_{REF} as a voltage.

The DCO 51 can be applied to not only a ring-type digitally-controlled oscillator, but also an LC-type digitally-controlled oscillator.

### Third Modified Example

FIG. 13 shows a third modified example of the present embodiment. In the first modified example, the output signal f_{DCO} of the DCO 31 is delayed by the DTC 44. In contrast, in the third modified example, as shown in FIG. 13, for example, a voltage offset Voff is given to the differential output signal f_{DCO} of the DCO 31 and supplied to the S/H 33, by a digital-to-analog converter (DAC) 61. Means for supplying the voltage offset is not limited to the DAC 61.

By thus giving the voltage offset Voff to the output signal f_{DCO} of the DCO 31, the PLL circuit which outputs a signal obtained by multiplying the reference clock signal f_{REF} by a decimal place number can be constituted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A phase detector, comprising:
an amplifier configured to amplify a voltage of a signal which is output from a digitally-controlled oscillator and is held based on a reference signal; and
an analog-to-digital converter configured to convert the voltage amplified by the amplifier into a digital signal, based on the reference signal.

2. The phase detector according to claim 1, further comprising:
a sample-and-hold circuit configured to hold the voltage of the signal output from the digitally-controlled oscillator, based on the reference signal.

3. The phase detector according to claim 1, wherein
the amplifier is a variable gain amplifier, and a gain of the variable gain amplifier is controlled based on an output signal of the analog-to-digital converter.

4. The phase detector according to claim 2, wherein
the sample-and-hold circuit comprises:
a booster circuit configured to boost the reference signal;
a transistor configured to control by an output signal of the booster circuit, and to pass through a voltage supplied from the digitally-controlled oscillator; and
a capacitor configured to charge with a voltage supplied from the transistor.

5. A digital phase-locked loop circuit, comprising:
a digitally-controlled oscillator configured to oscillate a signal, based on a control signal;
an analog-to-digital converter configured to convert a voltage of a signal which is output from the digitally-controlled oscillator and is held based on a reference signal, into a digital signal; and
a digital filter configured to produce the control signal to control the digitally-controlled oscillator, from an output signal of the analog-to-digital converter.

6. The circuit according to claim 5, further comprising
a sample-and-hold circuit configured to hold the voltage of the signal output from the digitally-controlled oscillator, based on the reference signal.

7. The circuit according to claim 5, further comprising
an amplifier configured to amplify the held voltage.

8. The circuit according to claim 7, wherein
the amplifier is a variable gain amplifier, and a gain of the variable gain amplifier is controlled based on the output signal of the analog-to-digital converter.

9. The circuit according to claim 5, further comprising
a digital-to-time converter to which the output signal of the digitally-controlled oscillator is supplied, wherein the digital-to-time converter gives a delay to the output signal of the digitally-controlled oscillator.

10. The circuit according to claim 5, further comprising
a digital-to-time converter configured to give a delay to the reference signal.

11. The circuit according to claim 5, further comprising
a waveform shaping circuit configured to shape the output signal of the digitally-controlled oscillator.

12. The circuit according to claim 5, further comprising
a circuit to which the output signal of the digitally-controlled oscillator is supplied, wherein the circuit gives a voltage offset to the output signal of the digitally-controlled oscillator.

13. The circuit according to claim 5, wherein
the digitally-controlled oscillator is an LC-type digitally-controlled oscillator.

14. The circuit according to claim 5, wherein
the digitally-controlled oscillator is a ring-type digitally-controlled oscillator.

15. The circuit according to claim 6, wherein
the sample-and-hold circuit comprises:
a booster circuit configured to boost the reference signal;
a transistor configured to control by an output signal of the booster circuit, and to pass through a voltage supplied from the digitally-controlled oscillator; and
a capacitor configured to charge with a voltage supplied from the transistor.

16. A digital phase-locked loop circuit, comprising:
a digitally-controlled oscillator configured to oscillate a signal, based on a control signal;
a sample-and-hold circuit configured to hold a voltage of a signal output from the digitally-controlled oscillator, based on the reference signal;
an amplifier configured to amplify the voltage held by the sample-and-hold circuit;
an analog-to-digital converter configured to convert the voltage amplified by the amplifier into a digital signal; and
a digital filter configured to produce the control signal to control the digitally-controlled oscillator, from an output signal of the analog-to-digital converter.

17. The circuit according to claim 16, wherein
the amplifier is a variable gain amplifier, and a gain of the variable gain amplifier is controlled based on the output signal of the analog-to-digital converter.

18. The circuit according to claim 16, further comprising
a digital-to-time converter to which the output signal of the digitally-controlled oscillator is supplied, wherein tie digital-to-time converter gives a delay to the output signal of the digitally-controlled oscillator.

19. The circuit according to claim 16, further comprising
a digital-to-time converter configured to give a delay to the output signal of the digitally-controlled oscillator.

20. The circuit according to claim 16, further comprising
a waveform shaping circuit configured to shape the output signal of the digitally-controlled oscillator.
